(19) United States
(12) Patent Application Publication
(10) Pub. No.: US 2004/0221891 A1
(43) Pub. Date: Nov. 11, 2004

(54) Down spout flow prevention device

(76) Inventor: Rod Barratt, Newtown (AU)

Correspondence Address: WILLIAM J. SAPONE, COLEMAN SUDOL SAPONE P.C., 714 COLORADO AVENUE, BRIDGE PORT, CT, 06605, US

(21) Appl. No.: 10/807,501

(22) Filed: Mar. 23, 2004

(30) Foreign Application Priority Data
Mar. 25, 2003 (AU) 2003100226

(51) Int. Cl. F16K 27/00

(52) U.S. Cl. 137/357

(57) ABSTRACT

A device (10) for restricting the flow of water through a down spout of a building roof guttering system. The device includes a housing (12), the housing (12) including a water flow path (28) extending between a water inlet (16) and a water outlet (22). The device (10) also includes a means (32) for restricting water flow along the water flow path (28). The water flow restriction means (32) is provided in the water flow path (28) between the water inlet (16) and water outlet (22). The device (10) also includes a port (30) for the supply of water to the device (10) from a water source. The port (30) is provided in the water flow path between the water inlet (16) and the water flow restriction means (32).

### FIELD OF THE INVENTION

The present invention relates generally to a device for reducing the risk of property damage due to fire. In particular, the invention relates to a device for reducing the risk of a fire initiating in or under a building roofline and is generally described in this context. However, it will be appreciated that the invention has broader application and is not limited to that particular use.

### BACKGROUND OF THE INVENTION

In the United States, Australia, and many other regions of the world, bush, forest, grass and scrub fires (bush, forest, grass and scrub fires are hereinafter referred to simply as “bushfires”) can result in loss of human and animal life, and frequently cause widespread property destruction and damage. Particularly disturbing, in terms of property, is the destruction and damage to homes, which can be financially and emotionally crippling to the victims.

Statistics suggest that, in the event of a bushfire, buildings commonly initially catch fire in the roof gutters. Burning embers, which are airborne as a result of the strong winds usually accompanying and fanning bushfires, land on the building roofs and become trapped in the roof gutters, whereupon they burn. Such fires are exacerbated if the gutters contain combustible debris such as leaves, twigs and the like.

A fire initiating in a roof gutter is difficult to access from ground level and is therefore difficult to extinguish. Further, once the fire spreads from the gutter to inside the building roof space it is virtually impossible to extinguish.

### OBJECTS OF THE INVENTION

It is an object of the present invention to reduce the likelihood of a building fire initiating in a roof gutter.

It is another object of the present invention to quell burning embers incident in a roof gutter.

### SUMMARY OF THE INVENTION

According to a broad aspect of the present invention, there is provided a device for restricting the flow of water through a down spout of a building roof guttering system. The device includes a housing, the housing including a water flow path extending between a water inlet in and a water outlet. The device also includes a means for restricting water flow along the water flow path. The water flow restriction means is provided in the water flow path between the water inlet and water outlet. The device also includes a port (or connector) for the supply of water to the device from a water source. The port is provided in the water flow path between the water inlet and the water flow restriction means.

The term “down spout”, as used above and following, is understood to mean a down spout or downpipe.

In a particularly preferred form the device is separately manufactured from a down spout section to which it is later connected.

Preferably, the water inlet is provided for attachment to the opening of a downwardly extending down spout section connected to a building roof gutter. The water outlet is provided for attachment to the opening of an upwardly extending down spout section connected to a stormwater drain or the like.

The inlet and outlet could adopt any practical size and shape, depending upon the dimensions of the down spout to which the device is to be connected.

In an alternative configuration, it is to be appreciated that the device could be integrally formed in a conventional down spout section.

Most preferably, the water flow restriction means is adjustable between a position substantially preventing the flow of water along the flow path from the water inlet to the water outlet, and a position enabling the flow of water between the water inlet and water outlet in a substantially unrestricted manner, The flow restriction means could adopt any practical form.

In one form, the water flow restriction means includes a plug for manually inserting into the water flow path. The plug is sized and shaped to substantially prevent the flow of water along the water flow path, and is manually removable to enable substantially unrestricted water flow along the flow path.

In another form, the water flow restriction means includes a plug, which is pivotally connected inside the housing in the water flow path. In this arrangement the plug could be manually adjusted via an actuator between a position substantially preventing water flow between the water inlet and water outlet; and a position enabling-substantially unrestricted water flow between the water inlet and water outlet.

The device has been designed primarily to enable a down spout and associated building roof guttering system to be backfilled with water from, for example, a garden hose. However, it is to be appreciated that the device could also be used, for example, to enable the capture and backfill of rainwater within a down spout and associated building roof guttering system.

The device enables a building owner/occupier faced with an approaching bushfire to restrict or block the flow of water through a section of roof guttering down spout. Once this has been done, the device can be used to backfill the down spout above the device and the roof gutter feeding the down spout with water. With the gutter backfilled with water, the water quells burning embers that subsequently land in the gutter.

Once the threat of fire has passed, the water flow restriction means can be “opened” to allow the water stored in the gutter to flow through the down spout and device, and into the stormwater system to which the down spout is connected.

In a preferred form, the device is manufactured from polyvinyl chloride (PVC) using an injection moulding process. It is to be appreciated, however, that the device could be manufactured from any other suitable material and by any other suitable manufacturing process.

The port could be of any practical size and configuration.

In a preferred form, the port includes means for connecting a water source thereto. The connection means could be of any practical form, including a screw threaded or clip arrangement.

The water source for connecting to the port could be of any practical form, including a garden hose, a water pipe or other water supply device. With the flow prevention means adjusted to prevent the flow of water between the water inlet and water outlet, the water source can supply (or backfill) water to the roof gutter via the port.

Preferably, the port includes a removable cap. The cap can be fitted to cover the port when use of the port is not required.

In one form, the port includes a second, preferably upwardly facing, attachment means on the inner side of the port. The second attachment means is provided for the connection of a hose, pipe, specially designed roof gutter extension having a conduit therein provided, or other conduit to the inner side of the inlet port. It is envisaged that the hose (or practical equivalent) could extend along the water flow path from the inner side of the inlet port, through the water inlet, through the down spout section leading to the roof gutter and along the roof gutter. Thus, in the event of a bushfire, a first hose (or equivalent) could feed water to the device, which in turn feeds water via a second hose (or practical equivalent) directly into the roof gutter.

Such an arrangement could facilitate the relatively quick wetting of the roof gutter in the event of a bushfire, thereby further reducing the likelihood of a building fire starting from embers falling into the roof gutter.

The hose (or practical equivalent) provided in the roof gutter could include perforations, spray jets or the like along at least part of its length to offer a type of sprinkler system in the gutter. This feature could be used to further enhance the fire protection of the device in the event of a bushfire.

The device has been designed primarily for protecting houses in the event of bushfires, However, it is to be appreciated that the device could be equally effective in protecting other types of buildings and structures from bushfires. Examples of other buildings and structures for which the device could prove effective in the protection from bushfires include industrial and commercial buildings, factories, garages, sheds, barns, carports, verandahs, patios and pergolas.

Further, it is to be appreciated that the device could be used in other applications where it is desired to restrict, prevent or otherwise control the flow of liquid through a conduit.

It will be convenient to hereinafter describe preferred embodiments of the invention with reference to the accompanying drawings. The particularity of the drawings is to be understood as not limiting the preceding broad description of the invention.

### BRIEF DESCRIPTION OF THE DRAWINGS

FIG. 1 is a front view of one embodiment of the device according to the present invention.

FIG. 2 is a front view of another embodiment of the device according to the present invention.

### DETAILED DESCRIPTION OF THE DRAWINGS

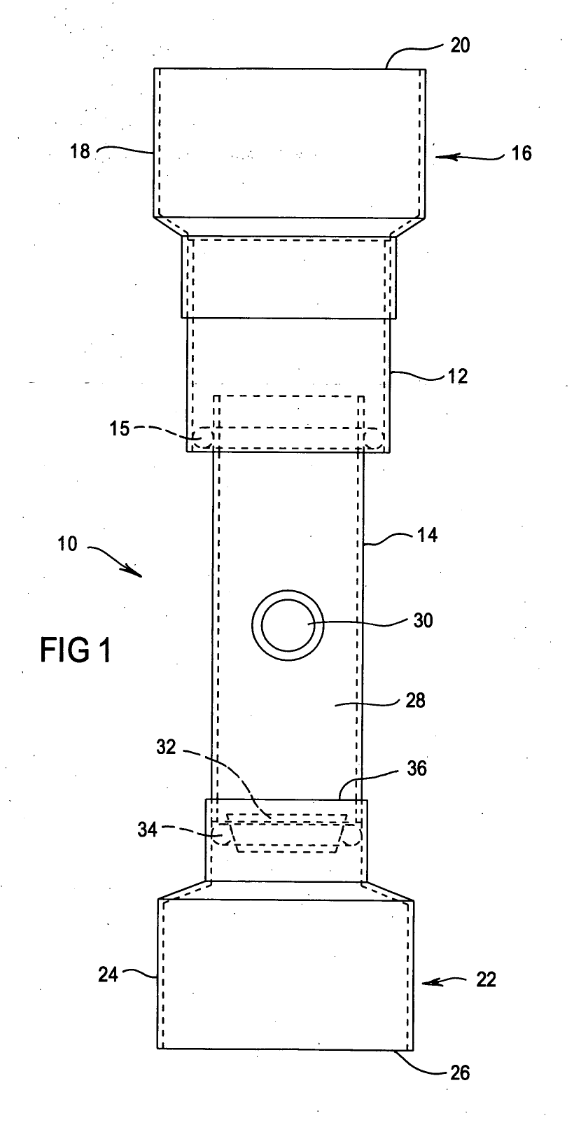

Referring to FIG. 1, there is provided a device 10 for restricting the flow of water through a down spout of a roof guttering system (for clarity, the down spout is not illustrated).

The device 10 includes a stationary cylindrical housing portion 12 and a movable cylindrical housing portion 14. The housing portion 14 is of a smaller cross-sectional diameter than that of housing portion 12, and is slidably movable in an upward direction (and partially into portion 12) from the position illustrated. An O-ring seal 15 (illustrated in a dashed line format) is provided between the inner wall of the housing portion 12 and the outer wall of the housing portion 14.

The housing portion 12 includes a water inlet 16. The water inlet 16 includes an inlet adaptor 18 for fitting about the upper end of the housing portion 12. The inlet adaptor 18 has a generally rectangular and upwardly facing opening 20 for snugly fitting around a generally downwardly facing opening of a rectangular down spout section, which is connected to an associated roof gutter.

The housing portion 14 includes a water outlet 22. The water outlet 22 includes an outlet adaptor 24 for fitting about the lower end of the housing portion 14. The outlet adaptor 24 has a generally rectangular and downwardly facing opening 26 for snugly fitting around a generally upwardly facing rectangular opening of a down spout section connected to a stormwater drain.

The housing portions 12 and 14, inlet adaptor 18 and outlet adaptor 24 are manufactured from polyvinyl chloride (PVC) using an injection moulding process.

The housing portions 12 and 14 include a water flow path 28 extending between the openings 20 and 26.

A port (or connector) 30 is provided in the wall of the housing portion 14. The port 30 includes a screw thread for the attachment of a garden hose, pipe, conduit or other water supply device. The port 30 also includes a screw-threaded cap (not illustrated) for closure of the port 30 when not required.

A means for restricting water flow along the flow path 28 is provided in the form of a hard plastic circular-shaped plug (or closure) 32 (illustrated in a dashed line format). The plug 32 is dimensioned to fit snugly within an O-ring seal 34, provided in the water flow path 28 and within the upper end of outlet adaptor 24. The O-ring seal 34 is illustrated in a dashed line format. The plug 32 creates a seal with the O-ring 34, thereby preventing water flowing along the flow path 28 between the water inlet 16 and water outlet 22. The plug 32 is removably fitted in the flow path 28 by manually lifting the housing portion 14 relative to the outlet adaptor 24 and housing portion 12. The plug 30 is then inserted through the outlet adaptor opening 36.

In normal operation, and in the absence of a bushfire threat, the plug 32 would be removed from the flow path 28 to allow rainwater to pass through the device from roof guttering (not illustrated) to the associated stormwater drain (not illustrated). A cap would also be fitted to the port 30 to prevent rainwater undesirably discharging from the device 10 through the port 30.

In this arrangement, the device 10 would function as a section of down spout, such that rainwater would pass downwardly through it to the stormwater drain.

When faced with the threat of an approaching bushfire, the plug 32 is fitted in the water flow path 28 in the manner previously described The cap fitted to the port 30 is removed and a garden house (or other suitable water supply device) is then attached to the port 30 via a screw-threaded connector.

Water is supplied through the port 30 from the garden hose. The plug 32 prevents the water entering through the port 30 from flowing downwardly to the stormwater drain. Consequently, the water backfills upwardly through the water flow path 28, the down spout section extending between the roof gutter and the device 10, and then into the gutter itself. The supply of water through the port 30 can be terminated once the gutter has filled with water to the desired depth.

Burning embers subsequently incident in the gutter are quelled by the water retained in the gutter by the device 10, thereby substantially reducing the likelihood of the building catching fire as a result of burning embers landing in the gutter.

Once the bushfire threat has passed, the port 30 can be opened to drain the gutter and down spout of the water stored therein. The housing portion 14 can then be lifted relative to the outlet adaptor 24 and housing portion 12 to remove the plug 32 through the outlet adaptor opening 36.

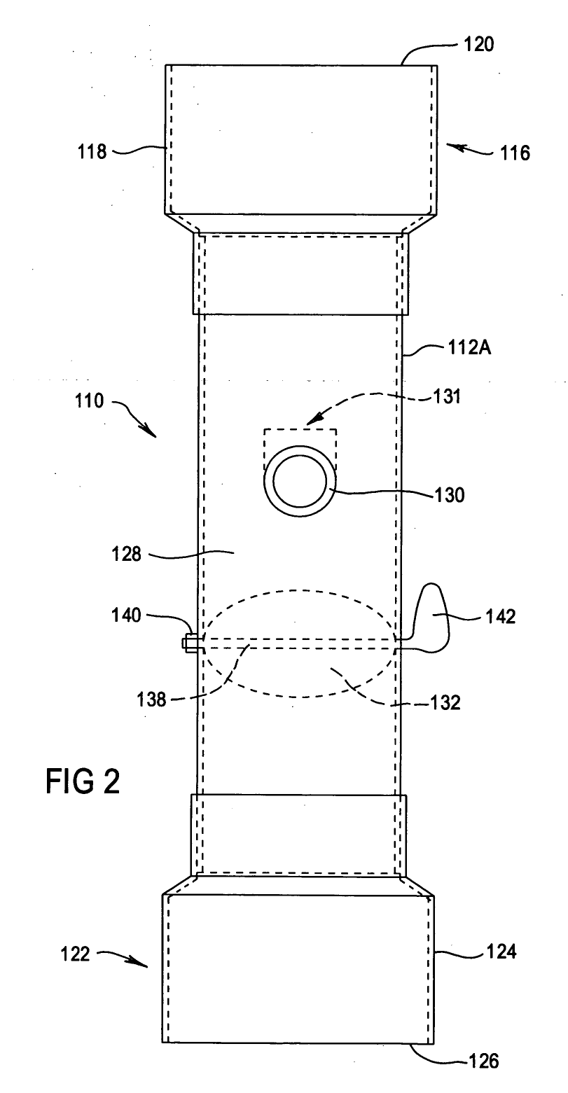

The device 10 illustrated in FIG. 2 is similar in a number respects to the device 10 illustrated in FIG. 1. Like or identical feature are not further discussed.

Referring to FIG. 2, the housing portions 12 and 14 of the embodiment illustrated in FIG. 1 have been replaced with a single housing 112A. The plug 132 is pivotally mounted within the water flow path 128 by a pivot axis 138. The axis 138 is retained in position by a nut 140, which is threadably attached to one end of the axis 138. Adjustment of the plug 132 between a position substantially preventing the flow of water along the flow path 128 (the “closed position”), and a position enabling the flow of water along the flow path in a substantially unrestricted manner (the “open position”) is controlled by a hand operated actuator 142. This arrangement advantageously does not require the fitment of the plug 132 in the water flow path 128 prior to using the device 110. Instead, all that is required is for adjustment of the actuator 142.

The plug 132, pivot axis 138 and/or the actuator 142 is provided with a means to lock the plug 132 in the open and closed positions. The locking means could adopt any suitable form.

The port 130 illustrated in FIG. 2 differs slightly form the port 30 in FIG. 1 in that the port 130 includes an upwardly facing internal connector 131 (shown in dashed line format). The connector 131 is provided for internally connecting one end of a conduit (not illustrated) downwardly extending through the device 110 to the port 130. The other end of the conduit would be located in the roof gutter (not illustrated) for the supply of water from a garden hose (not illustrated), through the port 130 and conduit to the roof gutter.

The conduit may include perforations or spray jets to assist in wetting the roof and guttering system against an approaching bushfire.

It is to be appreciated that the relative dimensions of the various components have not been drawn to scale, and consequently may vary from specific forms illustrated.

The present invention is useful in protecting a wide variety of buildings from the threat of fire, especially bushfires. The invention would also be effective when faced with other fire threats, including the burning of neighbouring buildings.

The present invention is capable of greatly reducing the likelihood of a building fire initiating in a roof gutter. In particular, the present invention is capable of effectively quelling any burning embers landing within a roof gutter.

The invention has been described in terms of use with water. However, advantageously, the invention could be used in conjunction with any suitable fluid, including foam retardant.

Advantageously, the invention can be relatively easily and cheaply fitted to any existing down spout, as well as newly installed down spouts.

Finally, it is to be understood that various alterations, modifications and/or additions may be introduced into the construction and arrangement of the parts previously described without departing from the spirit or ambit of this invention.

Having now described my invention, what I claim as new and desire to secure by Letters Patent is:

1. A device for restricting the gravity flow of water through a down spout of a building roof guttering system for creating a build up of water within the roof guttering system in order to protect the building from an approaching bushfire, the device comprising:
a housing;
the housing having a water flow path extending between a water inlet and a water outlet;
a closure in the form of a plug being provided in the water flow path between the inlet and the outlet for substantially preventing water flow along the flow path between the water inlet and water outlet;
the device being designed to replace a down spout section, with the water inlet provided for attachment to the opening of a downwardly extending down spout section connected to a building roof gutter, and the water outlet provided for attachment to the opening of an upwardly extending down spout section connected to a stormwater drain or the like;
the device also including a connector for the supply of water to the device from a garden hose for backfilling the roof guttering system with water in the event of an approaching bushfire;
the connector being provided in the water flow path between the water inlet and the closure, and being integrally formed with the housing wall and extending through the wall;
the connector having an outer port for connecting a garden hose thereto,
the connector also having an upwardly facing inner port within the housing, with the inner and outer ports connected by a secondary water flow path extending through the connector;
the inner port being provided for connecting to the lower end of a conduit 30 extending upwardly through the down spout, with the upper end of the conduit lying within the roof gutter for supplying water from a garden hose, through the device and to the roof gutter; and
wherein the housing comprises a first housing section and a second housing section, with the inlet provided in the first housing section and the outlet provided in the second housing section, with one of the first and second housing sections being slidably receivable in the other housing section to create an opening for fitting and removing the plug from within the housing.

2. A device according to claim 1, wherein the conduit includes perforations or spray jets to provide a gutter located water sprinkler.

3. A device for restricting the gravity flow of water through a down spout of a building roof guttering system for creating a build up of water within the roof guttering system in order to protect the building from an approaching bushfire, the device comprising:
a housing;
the housing having a water flow path extending between a water inlet and a water outlet;
a closure being provided in the water flow path between the inlet and the outlet for restricting water flow along the water flow path;
the closure being pivotally connected to the housing in the water flow path, enabling pivotal adjustment of the closure between a position substantially preventing water flow along the flow path between the water inlet and water outlet, and a position enabling substantially unrestricted water flow along the flow path between the water inlet and water outlet;
the device being designed to replace a down spout section, with the water inlet provided for attachment to the opening of a downwardly extending down spout section connected to a building roof gutter, and the water outlet provided for attachment to the opening of an upwardly extending down spout section connected to a stormwater drain or the like;
the device also including a connector for the supply of water to the device from a garden hose for backfilling the roof guttering system with water in the event of an approaching bushfire;
the connector being provided in the water flow path between the water inlet and the closure, and being integrally formed with the housing wall and extending through the wall;
the connector having an outer port for connecting a garden hose thereto;
the connector also having an upwardly facing inner port within the housing, with the inner and outer ports connected by a secondary water flow path extending through the connector;
the inner port being provided for connecting to the lower end of a conduit extending upwardly through the down spout, with the upper end of the conduit lying within the roof gutter for supplying water from a garden hose, through the device and to the roof gutter.

4. A device according to claim 3, wherein the conduit includes perforations or spray jets to provide a gutter located water sprinkler.

5. A device for restricting the flow of water through a down spout of a building roof guttering system according to claim 3, wherein the closure comprises a plug, which is sized and shaped to substantially prevent the flow of water along the water flow path.

6. A device for restricting the gravity flow of water through a down spout of a building roof guttering system for creating a build up of water within the roof guttering system in order to protect the building from an approaching bushfire, the device including:
a housing;
the housing including a water flow path extending between a water inlet and a water outlet;
a closure being provided in the water flow path between the inlet and the outlet for restricting water flow along the water flow path,
the closure being pivotally connected to the housing in the water flow path, enabling pivotal adjustment of the closure between a position substantially preventing water flow along the flow path between the water inlet and water outlet, and a position enabling substantially unrestricted water flow along the flow path between the water inlet and water outlet;
the device also including a port for the supply of water to the device from a water source, wherein the port is provided in the water flow path between the water inlet and the closure;
wherein the device is designed to replace a down spout section, with the water inlet provided for attachment to the opening of a downwardly extending down spout section connected to a building roof gutter, and the water outlet provided for attachment to the opening of an upwardly extending down spout section connected to a stormwater drain or the like.

7. A device for restricting the flow of water through a down spout of a building roof guttering system according to claim 6, wherein the closure comprises a plug, which is sized and shaped to substantially prevent the flow of water along the water flow path.

8. A device for restricting the flow of water through a down spout of a building roof guttering system, including:
a housing;
the housing including a water flow path extending between a water inlet and a water outlet;
a closure for restricting water flow along the water flow path, which is adjustable between a position substantially preventing the flow of water along the flow path from the water inlet to the water outlet, and a position enabling the flow of water between the water inlet and water outlet in a substantially unrestricted manner;
the closure being provided in the water flow path between the inlet and outlet;
the closure being pivotally connected to the housing in the water flow path, enabling pivotal adjustment of the closure between a position substantially preventing water flow between the water inlet and water outlet and a position enabling substantially unrestricted water flow along the flow path between the water inlet and water outlet;
the device also including a port for the supply of water to the device from a water source, wherein the port is provided in the water flow path between the water inlet and the closure;
wherein the device is designed to replace a down spout section, with the water inlet provided for attachment to the opening of a downwardly extending down spout section connected to a building roof gutter, and the water outlet provided for attachment to the opening of an upwardly extending down spout section connected to a stormwater drain or the like.

9. A device for restricting the flow of water through a down spout of a building roof guttering system according to claim 8, wherein the closure comprises a plug, which is sized and shaped to substantially prevent the flow of water along the water flow path.

10. A device for restricting the flow of water through a down spout of a building roof guttering system, including:
a housing;
the housing including a water flow path extending between a water inlet and a water outlet;
a means for restricting water flow along the water flow path;
the means being provided in the water flow path between the inlet and outlet;
the device also including a port for the supply of water to the device from a water source, wherein the port is provided in the water flow path between the water inlet and the water flow restriction means.

11. A device for restricting the flow of water through a down spout of a building roof guttering system according to claim 10, wherein the water flow restricting means is adjustable between a position substantially preventing the flow of water along the flow path from the water inlet to the water outlet, and a position enabling the flow of water between the water inlet and water outlet in a substantially unrestricted manner.

12. A device for restricting the flow of water through a down spout of a building roof guttering system according to claim 10, wherein the water flow restricting means includes a plug, which is sized and shaped to substantially prevent the flow of water along the water flow path.

13. A device for restricting the flow of water through a down spout of a building roof guttering system according to claim 12, wherein the plug is pivotally connected to the housing in the water flow path, enabling pivotal adjustment of the plug between a position substantially preventing water flow between the water inlet and water outlet and a position enabling substantially unrestricted water flow along the flow path between the water inlet and water outlet.

14. A device for restricting the flow of water through a down spout of a building roof guttering system according to claim 10, wherein the device is designed to replace a down spout section, with the water inlet provided for attachment to the opening of a downwardly extending down spout section connected to a building roof gutter, and the water outlet provided for attachment to the opening of an upwardly extending down spout section connected to a stormwater drain or the like.

15. A device for restricting the flow of water through a down spout of a building roof guttering system according to claim 12, wherein the housing comprises a first housing section and a second housing section, with the inlet provided in the first housing section and the outlet provided in the second housing section, with one of the first and second housing sections being slidably receivable in the other housing section to create an opening for fitting and removing the plug from within the housing.
